(19) United States
(12) Patent Application Publication
(10) Pub. No.: US 2011/0267495 A1
(43) Pub. Date: Nov. 3, 2011

(54) Automatic Pixel Binning

(76) Inventor: Lee Warren Atkinson, Houston, TX (US)

(21) Appl. No.: 12/770,004

(22) Filed: Apr. 29, 2010

(51) Int. Cl. H04N 5/235

(52) U.S. Cl. 348/229.1; 348/E05.037

(57) ABSTRACT

In accordance with at least some embodiments, a method for outputting video images is disclosed. The method starts by measuring the ambient light in a scene. When the ambient light in the scene is lower than a threshold, images of the scene are created in the analog domain by combining multiple pixel values from imaging cells in an image sensor. The analog image will have a lower resolution than the native resolution of the image sensor. The images of the scene are converted into the digital domain and up-sampled to match the native resolution of the image sensor. The up-sampled images are used as the outputted video images. When the ambient light in the scene is not lower than a threshold, images of the scene are outputted where each pixel value in the image is created from the pixel value from only one pixel cell in the image sensor.

### BACKGROUND

The picture quality of video cameras, for example a webcam, is a function of the ambient light in the scene, the pixel size of the sensor, and the exposure or frame rate. As the resolution of video cameras increase, the pixel size in the sensor continues to decrease. Light sensitivity of the sensors is a function of the pixel size. Light sensors with small pixel sizes may have poor signal to noise response when used capturing scenes with low ambient light.

### BRIEF DESCRIPTION OF THE DRAWINGS

For a detailed description of exemplary embodiments of the invention, reference will now be made to the accompanying drawings in which:

FIG. 1 is a block diagram of an imaging system 100 in an example embodiment of the invention.

FIG. 2 is a flow chart 200 in an example embodiment of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

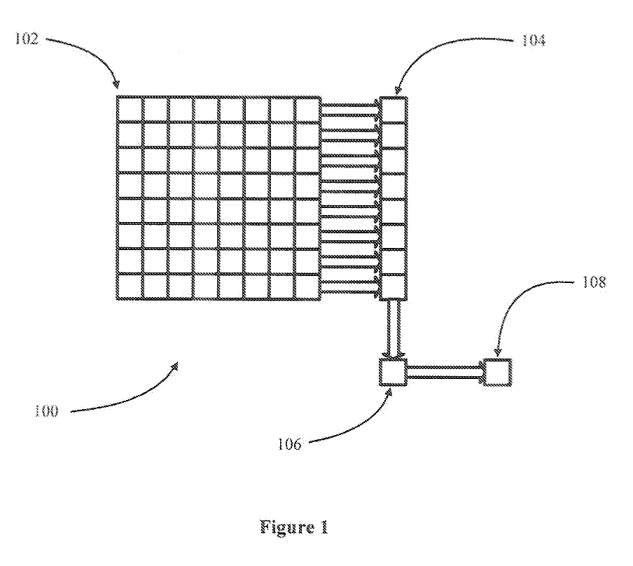

FIG. 1 is a block diagram of an imaging system 100 in an example embodiment of the invention. Imaging system 100 may be used in a video camera, for example a webcam or phone. Imaging system 100 comprises an image sensor 102, a shift register 104, an accumulator 106, and an analog to digital (ND) converter 108. Image sensor 100 comprises an array of light sensitive cells or pixels. The array of pixels is arranged in a plurality of columns and in a plurality of rows. Shift register 104 has a plurality of cells, where each cell corresponds to, and is coupled to, a row of the pixels in image sensor 102. Shift register is coupled to accumulator 106. Accumulator 106 is coupled to A/D converter 108.

Imaging system 100 may be operated in a number of different modes. In a native resolution mode the imaging system operates at the native resolution of the sensor. In the native resolution mode, each pixel in the final image corresponds to a single pixel in the image sensor. In a pixel binning mode, the charge from more than one cell or pixel in the image sensor may be used to create a final image pixel value. In a first pixel binning mode, the final image may have a lower resolution than the image sensor. In a second pixel binning mode, the final image may have the same resolution as the image sensor. Pixel binning is a method that combines the values of nearby pixels to improve the signal to nose ratio of the image, at the cost of the resolution of the image.

In the native resolution mode, light sensor 102 accumulates a charge in each pixel, during the exposure time, proportional to the amount of light from the scene that is imaged onto the pixel. Once the exposure time is over, the charge from each row of pixels is moved, one pixel at a time, into its corresponding shift register cell. The charge from each column of pixels is then moved, one cell at a time, from the shift register cells into accumulator 106. As each charge is moved into accumulator 106, the charge in the accumulator from the previous cell passes through A/D converted and is converted from the analog domain into the digital domain.

In a pixel binning mode, light sensor 102 accumulates charge in the same way during the exposure time. But as the charges are clocked or moved out of the image sensor, two or more changes may be combined before they are moved through A/D convertor 108. Two or more charges from each row can be combined by moving the charge from multiple pixels into the accumulators cells, before the column of charges is moved from the shift register cells into the accumulator, and then through the A/D converter. Two or more charges from the shift register cells can be combined in accumulator 106, before the charge is moved through A/D converter 108. Using these two methods, the charge from multiple pixels in a row can be combined, and the charge from multiple pixels in a column can be combined. Pixel binning may also be done in the digital domain by adding together the digital value of two or more pixels.

Imaging system 100 may have an image processing pipeline. Image processing pipeline may comprise shift registers 104, accumulator 106 and A/D converter 108. There may be additional components in image processing pipeline, for example a processor or an application specific integrated circuit (ASIC), memory, input/output (IO) circuitry, and the like. Image processing pipeline may be used to control image sensor 100 or another separate processor may be used. In some example embodiments of the invention, image processing pipeline may up-sample or down-sample the image data originating from image sensor 100.

Down sampling may be done using a pixel binning algorithm where two or more pixel values are combined to create a single pixel value. The down sampling may occur in the analog domain or in the digital domain. Up sampling may be used to increase the output resolution of the images. The up sampling may occur in the analog domain or in the digital domain. Up-sampling may use a replication method, an average value method, or the like. In one example embodiment of the invention, the down-sampling or pixel binning may be done in the analog domain and the up-sampling may be done in the digital domain.

In one example embodiment of the invention, the amount of up sampling used will be set equal to the amount of down sampling used. For example, when the down sampling combines four adjacent pixels, reducing the image resolution by a factor of four, up-sampling by a factor of four will be used. In this case the output resolution of the image would equal the native resolution of the sensor. But because pixel binning was used, the signal to noise ratio of the image will have been improved, but the actual or optical resolution (as opposed to the output resolution) of the image will have been degraded.

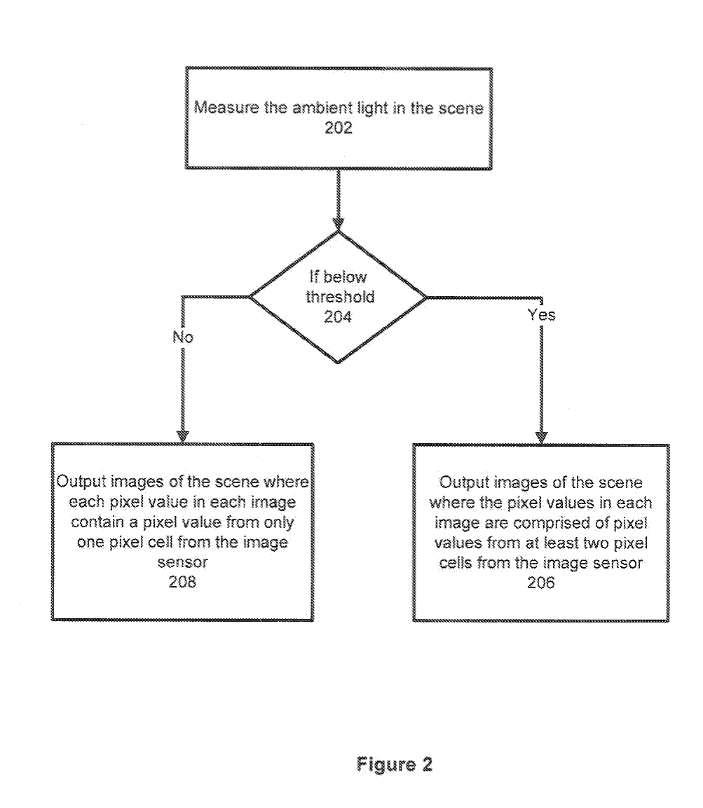

FIG. 2 is a flow chart for a method of outputting video images in an example embodiment of the invention. At step 202 the ambient light in a scene is measure. At step 204 the measured ambient light is compared to a threshold. When the ambient light is below the threshold, flow continues at step 206. When the ambient light is not below the threshold, flow continues at step 208. At step 206, when the ambient light is below the threshold, pixel binning is enabled. Therefore the images of the scene that are outputted have pixel values comprised of the pixel values from at least two cells in the image sensor. At step 208, when the ambient light is not below the threshold, pixel binning is disabled. Therefore the images of the scene that are outputted have pixel values containing a pixel value from only one pixel cell in the image sensor.

In some example embodiments of the invention, the images from step 206 are up-sampled so that the output resolution of the images from step 206 equal the output resolution of the images from step 208. The method shown in FIG. 2 may occur when the device first turns on. In other embodiments of the invention, the method shown in FIG. 2 could be done periodically. When done periodically the video camera would automatically adjust to increases or decreases in the ambient light in the scene.

In one example embodiment of the invention, the ambient light is compared to a first threshold. When the ambient light is not below the first threshold, pixel binning is disabled. When the ambient light is below the first threshold, but above a second threshold, pixel binning is enabled using a first level of pixel binning. When the ambient light is below the second threshold, pixel binning is enabled using a second level. Where the first level of pixel binning combines fewer pixels that the second level of pixel binning. For example the first level of pixel binning may combine the 4 adjacent pixels and the second level of pixel binning may combine 9 adjacent pixels.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for outputting video data, comprising:
measuring the ambient light in a scene;
when the ambient light is below a threshold value,
combining pixel values from an image sensor, using pixel binning in an analog domain, to produce a first image with a resolution that is less than a native resolution of the image sensor;
up-sampling, in the digital domain, the first image to produce a second image that has a resolution that matches the native resolution of the image sensor;
outputting the second image;
when the ambient light is not below the threshold value,
outputting images of the scene at the native resolution of the image sensor wherein each image of the scene is comprised of a plurality of pixel values, where each of the plurality of pixel values in each image is from only one imaging cell in the image sensor.

2. The method for outputting video data of claim 1, wherein the ambient light is measure using an auxiliary light sensor.

3. The method for outputting video data of claim 1, wherein when the ambient light is below the threshold value, the pixel binning combines at least four pixel cells of the image sensor.

4. The method for outputting video data of claim 3, further comprising:
when the ambient light is below a second threshold, the pixel binning combines at least nine pixel cells of the image sensor.

5. The method for outputting video data of claim 1, wherein the ambient light is measured periodically.

6. A video camera, comprising:
an image sensor with a plurality of imaging cells wherein the image sensor has a native resolution;
an image processing pipeline configured to output images from the image sensor, the image processing pipeline configured to measure an ambient light in the scene imaged by the image sensor;
when the ambient light is below a threshold value,
the image processing pipeline combines pixel values from the image sensor using pixel binning, in an analog domain, to produce a first image with a resolution that is less than a native resolution of the image sensor;
the image processing pipeline up-samples, in the digital domain, the first image to produce a second image that has a resolution that matches the native resolution of the image sensor;
the image processing pipeline outputs the second image;
when the ambient light is not below the threshold value, the image processing pipeline will output images of the scene wherein each image of the scene is comprised of a plurality of pixel values, where each of the plurality of pixel values in each image is from only one imaging cell in the image sensor.

7. The video camera of claim 6, further comprising
an auxiliary light sensor wherein the auxiliary light sensor is used to measure the ambient light in the scene.

8. The video camera of claim 6, wherein the image processing pipeline measures the ambient light periodically.

9. The video camera of claim 6, further comprising:
when the ambient light is below the first threshold, the image processing pipeline combines at least four pixel cells of the image sensor.

10. The video camera of claim 9, further comprising:
when the ambient light is below a second threshold, the image processing pipeline combines at least nine pixel cells of the image sensor.
